(19) United States
(12) Patent Application Publication
(10) Pub. No.: US 2025/0352954 A1
(43) Pub. Date: Nov. 20, 2025

(54) SORBENT MEMBRANES FOR LITHIUM HARVESTING, AND SYSTEMS AND METHODS FOR FABRICATION AND USE THEREOF

(71) Applicants: UNIVERSITY OF MARYLAND, COLLEGE PARK, College Park, MD (US); PROVECTUS ENGINEERED MATERIELS LTD., Vancouver (CA)

(72) Inventors: Mohamad I. AL-SHEIKHLY, Potomac, MD (US); Aiysha ASHFAQ, Brooklyn, NY (US); Claudio ARATO, Vancouver (CA)

(21) Appl. No.: 19/210,726

(22) Filed: May 16, 2025

Related U.S. Application Data
(60) Provisional application No. 63/648,320, filed on May 16, 2024.

(51) Int. Cl. B01D 67/00; B01D 71/26; B01D 71/48; B01D 71/56; C01D 15/00

(52) U.S. Cl. CPC B01D 67/009; B01D 67/0006; B01D 67/00931; B01D 71/261; B01D 71/262; B01D 71/48; B01D 71/56; C01D 15/00

(57) ABSTRACT

Lithium ions can be harvested from a low-grade source material, such as a slurry, brine, or other material, by using a sorbent membrane formed via radiation-induced graft polymerization. The sorbent membrane can have a polymer substrate with amine and/or amine-derivative monomers covalently bonded thereto. The sorbent membrane can be contacted with the lithium-containing source material such that at least some lithium ions in the source material bond to the monomers. The sorbent membrane can subsequently be subjected to one or more stripping processes so as to separate at least some of the lithium ions from the monomers, for example, by forming a lithium salt.

### CROSS-REFERENCE TO RELATED APPLICATIONS

The present application claims the benefit of and priority under 35 U.S.C. § 119(e) to and is a non-provisional of U.S. Provisional Application No. 63/648,320, filed May 16, 2024, entitled “Synthesis of Novel Membranes for Harvesting Lithium from Brines and Landfill Coal Ash Slurries,” which is hereby incorporated by reference herein in its entirety.

### FIELD

The present disclosure relates generally to harvesting and/or extracting lithium ions from various source materials (e.g., lithium deposits), and more particularly, to harvesting and/or extracting lithium ions using a sorbent membrane, for example, having one or more monomers grafted onto a polymer substrate.

### BACKGROUND

Significant quantities of lithium are present in low-grade deposits, such as not limited to brines (e.g., seawater, industrial leachates, geothermal brine, etc.), slurries (e.g., landfill water, wastewater, coal combustion residues or ash, etc.), or other materials (e.g., mineral-bearing soils or sediments). However, extracting lithium from these deposits continues to be a challenge. Existing methods like chemical precipitation, solvent extraction, or non-specific ion exchange often prove economically unviable or technically inadequate due to poor recovery, low selectivity, and high operational complexity when applied to such deposits. Consequently, these lithium deposits remain largely unexploited.

Embodiments of the disclosed subject matter may address one or more of the above-noted problems and disadvantages, among other things.

### SUMMARY

Embodiments of the disclosed subject matter provide sorbent membranes for use in harvesting lithium ions, for example, from low-grade deposits, as well as methods for fabrication and use of such membranes. In some embodiments, the sorbent membrane includes monomers grafted onto a polymer substrate, for example, via radiation-induced graft polymerization (RIGP), and the grafted monomers can have a strong affinity for lithium ions. In some embodiments, lithium ions in the low-grade deposit can selectively bond to the grafted monomers when the sorbent membrane is exposed to the low-grade deposit. Subsequent removal of the sorbent membrane from the deposit can thus extract the bonded lithium ions from the deposit. In some embodiments, the lithium ions can be released or removed from the monomers for subsequent use (or preparation for use) by one or more stripping processes.

In one or more embodiments, a method can comprise contacting a sorbent membrane with a lithium-containing source material. The sorbent membrane can comprise a polymer substrate and a plurality of monomers grafted to the polymer substrate. The plurality of monomers can comprise an amine monomer or an amine-derivative monomer covalently bonded to the polymer substrate. The contacting can be such that at least some lithium ions in the source material bond to the monomers. The method can further comprise, after the contacting, subjecting the sorbent membrane to one or more stripping processes so as to separate the lithium ions from the monomers of the sorbent membrane.

In one or more embodiments, a method for fabricating a sorbent membrane can comprise exposing a plurality of monomers and/or a polymer substrate to a dose of high-energy radiation. The high-energy radiation can comprise at least one of X-rays, a particle beam, or Gamma rays, and the plurality of monomers can comprise an amine monomer or an amine-derivative monomer. The method can further comprise contacting the plurality of monomers with the polymer substrate, such that the plurality of monomers are covalently bonded to the polymer substrate via one or more radiation-induced graft polymerization (RIGP) reactions. The contacting can be performed at a same time as or subsequent to the exposing. The sorbent membrane can comprise the polymer substrate and the plurality of monomers grafted to the polymer substrate, and the sorbent membrane can be constructed for harvesting lithium ions.

In one or more embodiments, a sorbent membrane for harvesting lithium ions can comprise a polymer substrate and a plurality of monomers grafted to the polymer substrate. The plurality of monomers can comprise an amine monomer covalently bonded to the polymer substrate and/or an amine-derivative monomer covalently bonded to the polymer substrate.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified schematic diagram illustrating aspects of harvesting lithium ions from a source material using a sorbent membrane, according to one or more embodiments of the disclosed subject matter.

FIGS. 1B-1E illustrate exemplary monomers that can be grafted to a polymer substrate to form a sorbent membrane for lithium ion harvesting, according to one or more embodiments of the disclosed subject matter.

FIG. 2A is a process flow diagram of a generalized method for synthesizing a sorbent membrane using a radiation-induced graft polymerization (RIGP) reaction, according to one or more embodiments of the disclosed subject matter.

FIG. 2B illustrates aspects of electron-beam-induced grafting of allylamine onto a poly(tetrafluoroethylene-co-hexafluoropropylene) (FEP) substrate using a direct grafting approach, according to one or more embodiments of the disclosed subject matter.

FIG. 2C illustrates aspects of electron-beam-induced grating of 4-vinylpyridine onto a polyethylene substrate using a direct grafting approach, according to one or more embodiments of the disclosed subject matter.

FIG. 2D illustrates aspects of electron-beam-induced grafting of a monomer onto a polyethylene substrate using an indirect grafting approach, which can be adapted to synthesize a sorbent membrane (e.g., by using an amine group monomer), according to one or more embodiments of the disclosed subject matter.

FIG. 3 is a process flow diagram of a generalized method for harvesting lithium ions from a source material using a sorbent membrane, according to one or more embodiments of the disclosed subject matter.

### DETAILED DESCRIPTION

### General Considerations

For purposes of this description, certain aspects, advantages, and novel features of the disclosed subject matter are described herein. The disclosed methods and systems should not be construed as being limiting in any way. Instead, the present disclosure is directed toward all novel and nonobvious features and aspects disclosed herein, alone and in various combinations and sub-combinations with one another. The methods and systems are not limited to any specific aspect or feature or combination thereof, nor do the disclosed aspects require that any one or more specific advantages be present, or problems be solved. The technologies from any aspect or example can be combined with the technologies described in any one or more of the other aspects or examples. In view of the many possible aspects to which the principles of the disclosed technology may be applied, it should be recognized that the illustrated aspects of the disclosure are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing aspects from discussed prior art, the numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Introduction

Disclosed herein are novel sorbent membranes for use in harvesting lithium ions, for example, directly from source materials, as well as systems and methods for fabrication and use of such sorbent membranes. In some embodiments, the sorbent membranes can be synthesized via radiation-induced graft polymerization (RIGP) reactions, for example, electron beam graft polymerization (EBGP). RIGP is a surface and bulk modification technique that can covalently bond monomers onto various polymer substrates. The exposure to high-energy radiation (e.g., X-ray, electron beam, gamma radiation, etc.) generates free radicals along the polymeric backbone of the substrate, which then reacts with the monomers to carry out one or more grafting polymerization reactions. By adjusting reaction conditions (e.g., monomer concentration, solvent type, temperature, radiation dose, dose rate, etc.) the degree of grafting (DoG) can be controlled, which may in turn affect harvesting performance (e.g., increase the lithium ion harvesting capacity of the resulting membrane).

In some embodiments, one or more monomers that have a relatively strong affinity for lithium ions (e.g., capable of forming a coordination bond with lithium) can be grafted onto a polymer substrate via RIGP to form the sorbent membrane, and the resulting sorbent membrane, or at least a portion thereof, can be exposed to (e.g., immersed in, dragged through, or otherwise contacted with) the source material such that lithium ions in the source material bond to the grafted monomers. After exposure, the bound lithium ions can be released from the sorbent membrane (e.g., by subjecting to one or more stripping processes) for further processing (e.g., purification) and/or use (e.g., as a component in a battery). In some embodiments, the release can include forming and/or recovering a lithium salt, such as but not limited to LiCl, Li(CO₃)₂, LiNO₃, or LiOH. The efficient and facile harvesting offered by embodiments of the disclosed subject matter can allow for recovery of valuable lithium ions from various source materials, including low-grade deposits and waste products, such as, but not limited to industrial brines, produced wastewater, and coal ash slurries.

### Sorbent Membranes

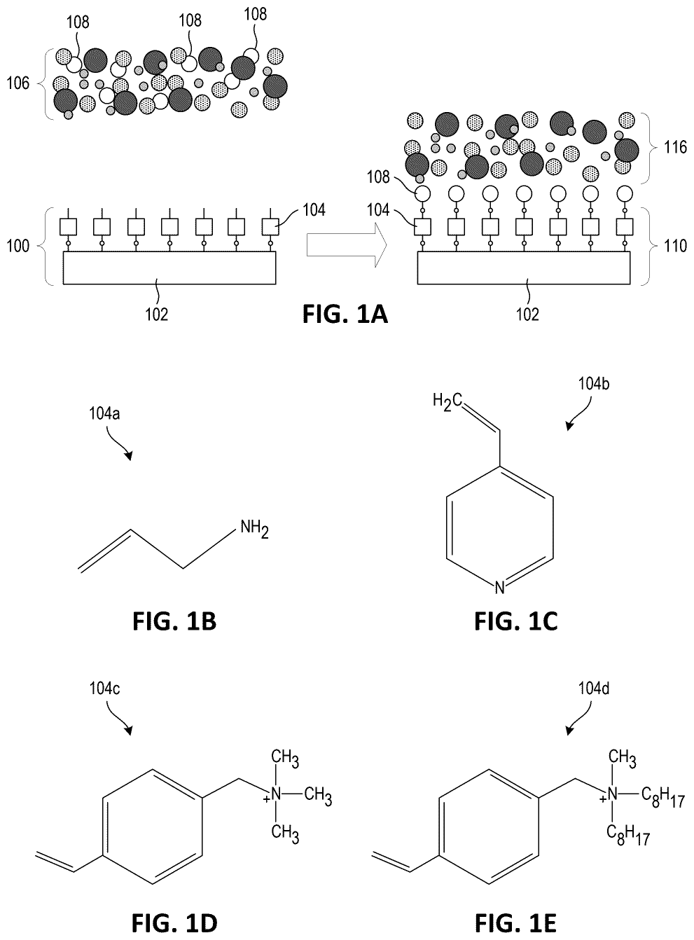

A sorbent membrane 100 can be synthesized by RIGP to graft monomers 104 onto a polymer substrate 102, for example, as shown in FIG. 1A. In some embodiments, the monomers 104 can comprise an amine monomer (e.g., having a primary, secondary, or tertiary amine group) or an amine-derivative monomer (e.g., quaternary ammonium monomer). In some embodiments, all of the monomers 104 can be the same (e.g., all the same amine monomer or amine-derivative monomer). Alternatively, in some embodiments, at least some of the monomers can be different. The degree of grafting (DoG) can be determined through measurement of the difference between the weight of the polymer substrate before grafting, W₀, and its weight after grafting, W_{g}, according to Equation (1):

$$Degree of grafting ( wt \% ) = \frac{{W}_{g} - {W}_{0}}{{W}_{0}} \times 100 \qquad ( 1 )$$

As the DoG increases, the concentration of the covalently attached monomers 104 on the polymer substrate 102 also increases. In some embodiments, a higher concentration of monomers on the surface of the polymer substrate may enhance the lithium ion harvesting capacity of the resulting sorbent membrane 100.

In some embodiments, the selection of monomers for grafting can be based at least in part on its affinity for lithium ions. For example, hard bases (e.g., a primary amine), which have small, relatively nonpolarizable donor atoms, show a stronger affinity for lithium ions than soft bases (e.g., tertiary amine), which are more polarizable. As disclosed in Olsher et al., “Coordination Chemistry of Lithium Ion: A Crystal and Molecular Structure Review,” Chem. Rev., 1991, 91 (2): pp. 137-164, which is incorporated by reference herein in its entirety, hard groups can include H₂O, OH⁻, F⁻, CH₃CO₂⁻, PO₄³⁻, SO₄²⁻, Cl, CO₃²⁻, ClO₄⁻, NO₃⁻, ROH, RO⁻, R₂O, NH₂, RNH₂, and N₂H₄; borderline groups can include R, N₃⁻, Br⁻, NO₂⁻, SO₂²⁻, and N₂; and soft groups can include R₂S, RSH, RS⁻, I⁻, SCN⁻, S₂O₃²⁻, R₃P, R₃As, (RO)₃P, CN−, RNC, CO, H⁻, and R⁻, where in the foregoing listings stands for an alkyl or aryl group.

Alternatively or additionally, the monomer selection can take into account the relationship between the monomer and the polymer substrate (e.g., the capability to successfully graft onto the material of the substrate, the geometry of the substrate, etc.), aspects of the grafting process (e.g., the radiation to be used, direct versus indirect RIGP, etc.), and/or aspects of the harvesting process (e.g., affinity to undesirable materials in the source material, etc.). Other considerations for selection of materials for the monomers and/or the polymer substrate are also possible according to one or more contemplated embodiments.

In some embodiments, one or more of the monomers 104 can comprise an amine group (e.g., primary, secondary, or tertiary amine groups), which have a solid affinity for lithium ions. For example, one or more of the monomers 104 can be formed of and/or comprise allylamine 104a, as shown in FIG. 1B. Alternatively or additionally, in some embodiments, one or more of the monomers 104 can have at least one vinyl group (e.g., 1-3 vinyl groups), for example, 4-vinylpyridine 104b, (vinylbenzyltrimethyl)ammonium (VBTMA-Cl) 104c, or vinylbenzyl-(methyl-di-octyl)-ammonium chloride (VBMDOA-Cl) 104d, as shown in FIGS. 1B-1E, respectively.

It should be noted, however, that not all monomers that have strong affinity for lithium ions are necessarily equal. Indeed, a sorbent structure that may be advantageous for one process may be disadvantageous for another. For example, both allylamine and 4-vinylpyridine are nitrogen-based ligands with amine groups, but allylamine has a primary amine group and 4-vinylpyridine has a tertiary amine group. The structure of 4-vinylpyridine exhibits a resonance in the ring that polarizes the nitrogen base, making it less suitable for strong coordination with the lithium ions. On the other hand, the stabilizing effect of the resonance contributes to the generally higher DoG of 4-vinylpyridine on polymer substrates. The free radical on the 4-vinylpyrdine can be stabilized by its proximity to the resonance ring, which can allow it to propagate and ultimately have higher DoG and more sites for lithium-nitrogen coordination. In contrast, resonance or electron-donating groups that could delocalize the electron do not stabilize the allylamine radical. This, in turn, means propagation is less likely, and getting higher degrees of grafting of allylamine onto polymer substrates may be more challenging.

When the sorbent membrane 100 is exposed to a source material 106, the monomers 104 bonded to the substrate 102 can adsorb the lithium ions 108 from the source material 106, thereby forming a lithium-loaded membrane 110 and a lithium-depleted (at least partially) source material 116, as shown schematically in FIG. 1A. In some embodiments, the source material 106 can be a brine or slurry, such as seawater, industrial brine, wastewater, or coal ash slurry. For example, the monomers 104 can be amine monomers or amine-derivative monomers, and the harvesting capacity of the sorbent membrane 100 can be at least 7 milligrams of lithium (e.g., in the form of LiCl salt) per gram of monomers 104 (e.g., sorbent). In some embodiments, the sorbent membrane 110 with harvested lithium ions 108 can be removed from the depleted source material 116, and subjected to one or more stripping processes to recover (e.g., release from, sever the bond to, or otherwise separate from the monomers of the membrane) some or all of the harvested lithium ions 108. In some embodiments, the stripping process(es) can allow the sorbent membrane 100 to be reused for additional lithium ion harvesting from the same or different source material.

### Sorbent Membrane Synthesis Methods

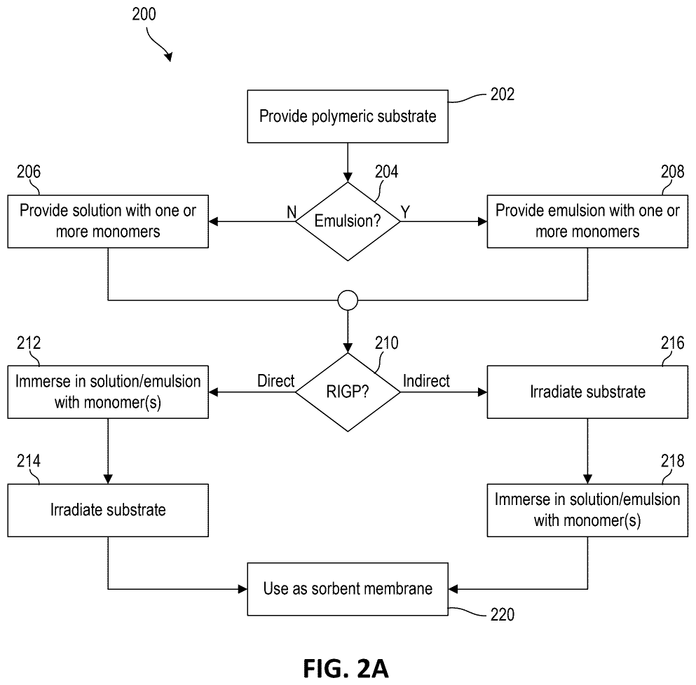

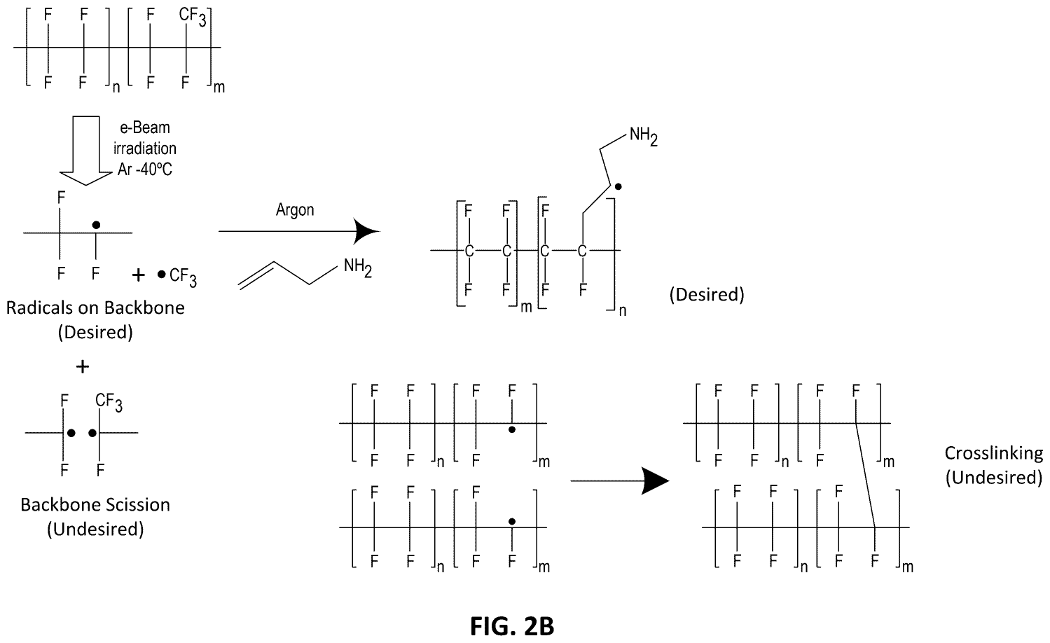

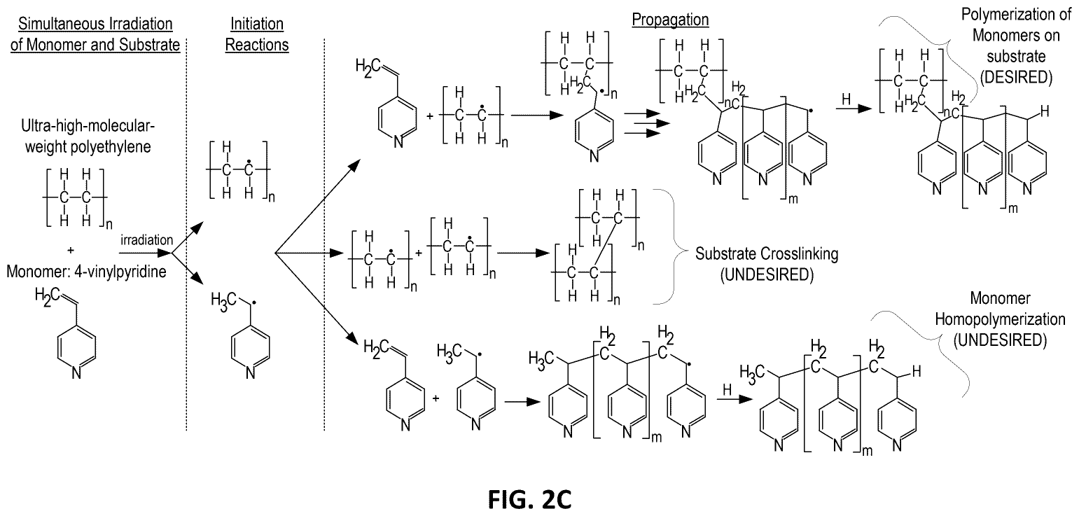

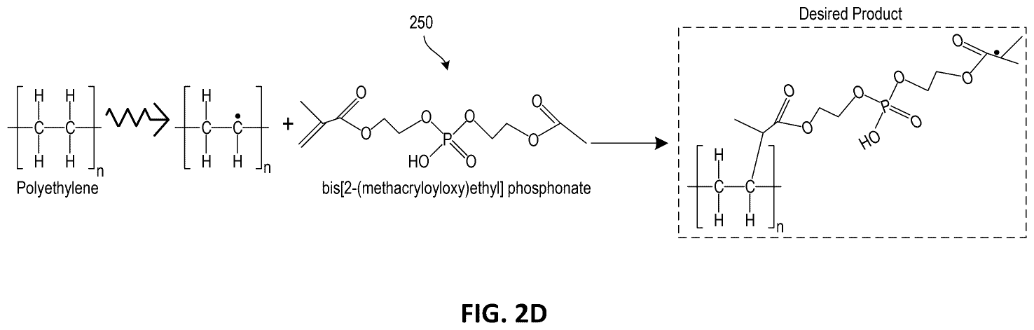

FIG. 2A shows a method 200 for synthesis of a sorbent membrane, such as but not limited to sorbent membrane 100. The method 200 can initiate at process block 202, where a polymer substrate (e.g., substrate 102 in FIG. 1A) can be provided. In some embodiments, the provision of process block 202 can include synthesizing and/or shaping the polymer substrate. In some embodiments, the polymer substrate can take the form of a flat sheet or membrane, for example, as shown by substrate 102 in FIG. 1A. Alternatively or additionally, in some embodiments, the polymer substrate, or a portion thereof, can take the form of a fiber, a hollow cylinder, a winged or multi-lobed structure (e.g., as described in U.S. Pat. No. 10,441,940, issued Oct. 15, 2019 and entitled “Polymers Grafted with Organic Phosphorus Compounds for Extracting Uranium from Solutions,” which structures are hereby incorporated by reference herein), or any other shape or structure.

In some embodiments, the polymer substrate can be composed of and/or comprise a polyolefin, a halogenated polymer, a polyester, or a polyamide. For example, the polyolefin can be polypropylene (PP) or a polyethylene (PE), such as ultra-high-molecular-weight PE (UHMWPE) (e.g., having a molecular mass of at least 3.5 million amu), low-density PE (LDPE) (e.g., having a density of 930 kg/m³ or less), or high-density PE (HDPE) (e.g., having a density greater than 930 kg/m³). For example, the halogenated polymer can be boronated or fluorinated co-polymers with a backbone of polyethylene. For example, the halogenated polymer can be a fluorinated polymer such as poly(tetrafluoroethylene-co-hexafluoropropylene) (FEP) or polytetrafluoroethylene (PTFE). For example, the polyester can be polyethylene terephthalate (PET), and the polyamide can be nylon 6 (polycaprolactam). In some embodiments, the material for the polymer substrate can be selected from the group consisting of UHMWPE, FEP, or PTFE.

The method 200 can proceed to decision block 204, where it is determined if an emulsion technique should be used for grafting of monomers (e.g., monomers 104 in FIG. 1A). The monomers can be an amine monomer or an amine-derivative monomer, for example, as described above with respect to FIGS. 1A-1E. If no emulsion is desired, the method 200 can proceed to process block 206, where the constituent monomers for grafting can be provided in solution. In some embodiments, the monomer solution can be prepared in an ionic aqueous solution or an organic solvent, such as but not limited to dimethyl sulfoxide (DMSO) or isopropanol (2-propanol). Alternatively, if an emulsion is instead desired at decision block 204, the method 200 can proceed to process block 208, where the constituent monomers for grafting can be provided in an emulsion. In some embodiments, the monomer emulsion can be prepared in an aqueous solution and/or using non-toxic surfactants (e.g., food-safe additives or materials generally recognized as safe, for example, as listed in the Select Committee on GRAS Substances (SCOGS) database maintained by the Food and Drug Administration (FDA)). In some embodiments, the aqueous solution containing the monomers can be purged (e.g., with nitrogen, argon, and/or nitrous oxide) to provide anoxic and/or anaerobic conditions. In some embodiments, the purging may be concurrent with subsequent exposure to radiation for grafting (e.g., process block 214 or 216). For example, the aqueous solution can be purged with nitrous oxide to optimize, or at least improve, the conversion of radiolytically produced hydrated electrons from radiolysis of water to hydroxyl radicals.

The method 200 can proceed from either process block 206 or process block 208 to decision block 210, where it is determined which grafting approach will be employed. In particular, the disclosed sorbent membranes can be synthesized using either a direct grafting approach (e.g., where the substrate and monomer solution are irradiated simultaneously) or an indirect grafting approach (e.g., where the substrate is irradiated prior to contacting the substrate with the monomer solution).

If a direct grafting approach is desired, the method 200 can proceed to process block 212, where the polymer substrate, or a part thereof, is immersed in or otherwise exposed to the solution containing the monomers, and the substrate and solution are simultaneously irradiated at process block 214. For example, the polymer substrate can be submerged in an oxygen-free (anaerobic to anoxic) monomer solution, and then irradiated at conditions (e.g., a total dose, dose rate, and/or temperature) to induce the targeted grafting of the monomer onto the polymer, thereby forming a sorbent membrane for optimal selective lithium ion separation and recovery. The irradiation of process block 214 can employ high-energy radiation (e.g., comprising at least one of X-rays, a particle beam, or Gamma rays). For example, ionizing radiation can be generated from electron beam accelerators and/or gamma radiation techniques.

Hydroxyl radicals are the main responsible species for producing free radicals on polymeric and/or monomeric substrates through addition and abstraction reactions, such as reflected in the following equations:

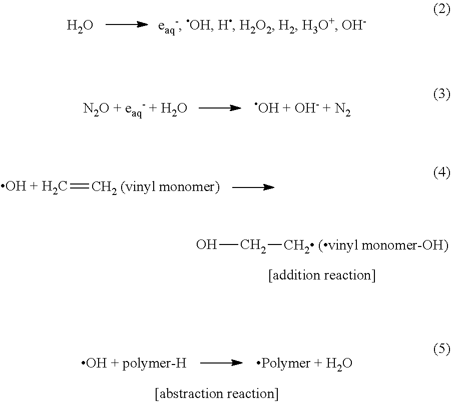

In some embodiments, the monomers can be allylamine, and the RIGP reaction can employ a direct grafting approach, for example, as shown in FIG. 2B. Alternatively, in some embodiments, the monomers can be 4-vinylpyridine, and the RIGP reaction can employ a direct grafting approach, for example, as shown in FIG. 2C. There are several factors that can be considered to enhance the DoG achieved by the RIGP approach of process blocks 212-214. For example, some solvents can enhance the DoG at certain concentrations, but their use may also decrease grafting if the monomer is not immiscible. In some embodiments, solvent type and ligand concentration can be selected to optimize, or at least improve, monomer grafting.

The dose, dose rate, and temperature during irradiation can also affect the DoG. For example, the ligand concentration can be less than or equal to 10M, such as within a range of 0.025-1M (e.g., about 0.25M). For example, the dose rate can be in a range of 100-800 kGy/hour, inclusive, for electron beam, or the dose rate can be in a range of 1-50 kGy/hour, inclusive, for gamma radiation. For example, the total administered dose can be in a range of 10-300 kiloGray (kGy), such as 50-150 kGy, inclusive, and/or the temperature can be in a range of 15-50° C., such as 20-30° C., inclusive. In some embodiments, the irradiation of process block 214 can be conducted in an inert environment, for example, using gases such as N₂ or Ar. Alternatively or additionally, when the monomer is in an aqueous solution, N₂O gas can be used to maximize, or at least increase, the yield of hydroxyl radicals during water radiolysis and/or to facilitate the creation of radicals.

If an indirect grafting approach is desired at decision block 210, the method 200 can instead proceed to process block 216, where the polymer substrate, or a part thereof, can be irradiated, and then immersed or otherwise exposed to the solution containing monomers at process block 218. In some embodiments, the irradiation of process block 216 can involve dry radiation, for example, conducted in dry ice to preserve the carbon-centered radicals generated on the polymeric backbone. The irradiation of process block 216 can employ high-energy radiation (e.g., comprising at least one of X-rays, a particle beam, or Gamma rays). For example, ionizing radiation can be generated from electron beam accelerators and/or gamma radiation techniques. The monomer solution can be added after irradiation to induce grafting of the monomers onto the irradiated polymer, thereby avoiding exposure of the monomer solution to the high-energy radiation. In some embodiments, the RIGP reaction employing the indirect approach can be similar to that shown in FIG. 2D (e.g., by replacing monomer 250 with an appropriate amine group monomer).

After either process block 214 or process block 218, the method 200 can proceed to process block 220, where the resulting sorbent membrane can be used or adapted for use. For example, the polymer substrate with monomers grafted thereon can be removed from the solvent and washed, for example, to remove, or at least reduce, any undesired products from the irradiation (e.g., monomer homopolymerization, substrate crosslinking, etc.). Alternatively or additionally, the sorbent membrane can be machined or formed into a desired shape for subsequent use (e.g., sheet, cylinder, hollow fiber, etc.). Alternatively or additionally, the sorbent membrane can be coupled or otherwise assembled together with other components (e.g., holder, positioner, actuator, etc.) for performing lithium ion harvesting.

Although blocks 200-220 of method 200 have been described as being performed once, in some embodiments, multiple repetitions of a particular block may be employed before proceeding to the next decision block or process block. In addition, although blocks 200-220 of method 200 have been separately illustrated and described, in some embodiments, blocks may be combined and performed together (simultaneously or sequentially). Moreover, although FIG. 2A illustrates a particular order for blocks 200-220, embodiments of the disclosed subject matter are not limited thereto. Indeed, in certain embodiments, the blocks may occur in a different order than illustrated or simultaneously with other blocks. In some embodiments, method 200 can include steps or other aspects not specifically illustrated in FIG. 2A. Alternatively or additionally, in some embodiments, method 200 may comprise only some of blocks 200-220 of FIG. 2A.

### Lithium Ion Harvesting Methods

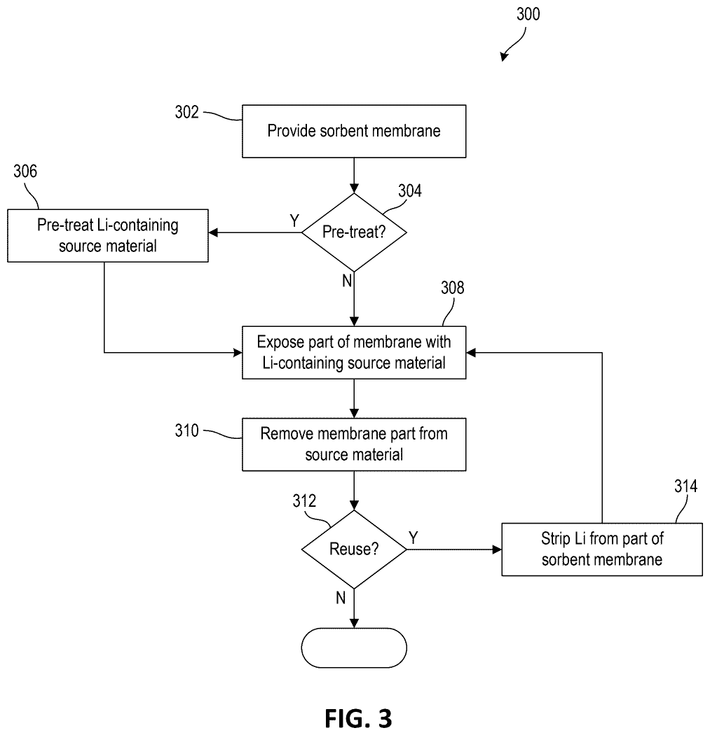

FIG. 3 shows a method 300 for harvesting lithium ions using a sorbent membrane, such as but not limited to sorbent membrane 100. The method 300 can initiate at process block 302, where the sorbent membrane can be provided. In some embodiments, the provision of process block 302 can include synthesizing the sorbent membrane, for example, employing method 200 of FIG. 2A. Alternatively or additionally, the provision of process block 302 can include assembling the sorbent membrane into a harvesting apparatus, for example, configured to position the sorbent membrane into contact with and/or remove the sorbent membrane from a source material.

The method 300 can proceed to decision block 304, where it is determined if pretreatment of the source material is desired. In some embodiments, the multitude of ions in some source materials (e.g., brine, dirt, etc.) can interfere with the membrane's capacity to extract as much lithium ions as possible. For example, other cations (e.g., sodium ions, magnesium ions) may compete with lithium ions for coordination with the monomers grafted on the polymer substrate, and such other cations may be present in the source material at higher concentrations than the lithium ions. To minimize, or at least reduce, competition from these other cations, pretreatment may be used to remove and/or neutralize such cations. Alternatively or additionally, removal of other components (e.g., uranium) from the source material may be desired prior to lithium ion harvesting.

If pre-treatment is desired, the method 300 can proceed to process block 306, where the source material can be subjected to one or more pre-treatment processes. In some embodiments, the pre-treatment process(es) can include removing at least some salts and/or cations from the source material, for example, using nitric acid. Alternatively or additionally, the pre-treatment can include removing at least some uranium from the source material, for example, using a different sorbent material (e.g., as described in U.S. Pat. No. 10,441,940, issued Oct. 15, 2019 and entitled “Polymers Grafted with Organic Phosphorus Compounds for Extracting Uranium from Solutions,” which uranium removal processes and structures are hereby incorporated by reference herein).

After process block 306, or if pre-treatment was not desired at decision block 304, the method 300 can proceed to process block 308, where the sorbent membrane, or at least part thereof, can be exposed to (e.g., contacted with) the Li-containing source material. In some embodiments, the exposure of process block 308 can involve immersing the sorbent membrane within the source material (e.g., brine or slurry) and/or moving the sorbent membrane through and/or within the source material. In some embodiments, the exposure of process block 308 can continue until a desired lithium ion harvesting capacity has been achieved, until the sorbent membrane has become saturated with lithium ions, until a predetermined duration has been reached, or according to any other criteria. After process block 308, the method 300 can proceed to process block 310, where the sorbent membrane can be removed from and/or cease contact with the source material, leaving behind a source material that has been at least partially depleted of lithium ions.

The method 300 can proceed to decision block 312, where it is determined if the sorbent membrane will be reused. If reuse of the membrane is desired, the method 300 can proceed to process block 314, where at least some of the captured lithium ions are removed or released from the sorbent membrane. For example, the lithium ions can be removed from the sorbent membrane by stripping with hydrochloric acid. In some embodiments, the released lithium ions from the sorbent membrane can be collected for use in another application, for example, as a constituent material in a lithium ion battery. After removal of the lithium ions, the sorbent membrane can then be reused for another round of harvesting at process block 308, for example, without further processing. Alternatively, the lithium ion removal of process block 314 can occur regardless of whether the sorbent membrane will be reused for further harvesting (e.g., the sorbent membrane can be discarded after lithium ion removal).

### Fabricated Examples and Experimental Results

Using electron-beam graft polymerization (EBGP), the polymer tertiary amine group in the form of 4-vinylpyridine was grafted onto various polymer substrates, in particular, an ultra-high molecular weight polyethylene (UHMWPE) substrate, a poly(tetrafluoroethylene-co-hexafluoropropylene) (FEP) substrate, a polypropylene (PP) substrate, and a high-density polyethylene (HDPE) substrate. Additionally, the primary amine group in the form of allylamine was grafted onto FEP and UHMWPE substrates. Table 1 below summarizes the synthesis characteristics of the fabricated sorbent membranes.

TABLE 1
Degree of grafting (DoG) for fabricated sorbent membranes

| | | Highest | Avg. |
|---|---|---|---|
| | | DoG | Standard |
| Substrate | Monomer | Achieved | Deviation |
| Ultra-High Molecular Weight | 4-vinylpyridine | 30% | +/−10% |
| Polyethylene (UHMWPE) | | | |
| Poly(tetrafluoroethylene-co- | 4-vinylpyridine | 51% | +/−10% |
| hexafluoropropylene) (FEP) | | | |
| Polypropylene (PP) | 4-vinylpyridine | 8% | +/−5% |
| High-Density Polyethylene | 4-vinylpyridine | 7% | +/−8% |
| (HDPE) | | | |
| Poly(tetrafluoroethylene-co- | Allylamine | 5% | +/−2% |
| hexafluoropropylene) (FEP) | | | |
| Ultra-High Molecular Weight | Allylamine | 2% | +/−1% |
| Polyethylene (UHMWPE) | | | |

While higher DoGs were achievable for 4-vinlypyridine as compared to allylamine, the higher DoG did not necessarily equate to a greater capacity for lithium ion extraction. For example, allylamine grafted onto FEP extracted a significant amount of lithium ions from brine (as shown in Table 2 below), implying that allylamine had a greater capacity for lithium ion extraction despite its lower DoG. Other factors can be considered when selecting polymer substrates and monomers. For example, working with 4-vinylpyridine can be challenging as it requires storage in a dry environment below 10° C. to prevent homopolymerization. Since irradiations are performed at room temperature, some of the monomer may be lost to homopolymerization and thus would not be available for grafting.

Inductively Coupled Plasma-Optical Emission Spectroscopy (ICP-OES) was used to quantify the lithium ion harvesting capacity of the fabricated sorbent membrane. In particular, ICP-OES analysis was used to determine the concentration of lithium ions in brine before and after it was stirred with the sorbent membranes. The results of lithium ion harvesting are shown for two sorbent systems in Table 2. A high harvesting capacity of ≅8 mg of lithium per gram sorbent was achieved for allylamine. Further increases in harvesting capacity may be achievable with improvements in grafting density, for example, via optimization of the RIGP reaction (e.g., by using an emulsion approach).

TABLE 2
Lithium ion harvesting capacity for fabricated sorbent membranes

| | | Extraction capacity |
|---|---|---|
| Sorbent Type | DoG | (mg Li/g of sorbent) |
| 4-vinylpyridine grafted on UHMWPE | 20% | 7.6 mg/g |
| Allylamine grafted on FEP | 5% | 8.0 mg/g |

Once the lithium ions are adsorbed onto the sorbent membrane, the lithium ions can be stripped from the sorbent membrane for subsequent practical use. To strip the lithium ions, dilute hydrochloric acid (HCl) was used, which was effective to strip about 7% of the captured lithium, as shown in Table 3. The concentration of the acid can be increased to increase the stripping capacity, and/or the stripping process can be repeated multiple times.

TABLE 3
Stripping of lithium from sorbent membranes using dilute HCl

| Sample Type: 4-vinylpyridine | Lithium Ion | |
|---|---|---|
| grafted on UHMWPE | Concentration (mg/L) | |
| Uptake by Membrane | 4 | mg/L |
| Stripped from Membrane | 0.289 | mg/L |

| | |
|---|---|
| Stripping Capacity | 7.2% |

### Conclusion

Any of the features illustrated or described herein, for example, with respect to FIGS. 1A-3, can be combined with any other feature illustrated or described herein, for example, with respect to FIGS. 1A-3, to provide configurations, systems, devices, structures, methods, aspects, or embodiments not otherwise illustrated or specifically described herein. All features described herein are independent of one another and, except where structurally impossible, can be used in combination with any other feature described herein. In view of the many possible aspects to which the principles of the disclosed technology may be applied, it should be recognized that the illustrated features are only examples and should not be taken as limiting the scope of the disclosed technology. Rather, the scope is defined by the following claims. Applicants therefore claim all that comes within the scope and spirit of these claims.

1. A method comprising:
contacting a sorbent membrane with a lithium-containing source material, the sorbent membrane comprising a polymer substrate and a plurality of monomers grafted to the polymer substrate, the contacting being such that at least some lithium ions in the source material bond to the monomers; and
after the contacting, subjecting the sorbent membrane to one or more stripping processes so as to separate at least some of the lithium ions from the monomers of the sorbent membrane,
wherein the plurality of monomers comprises an amine monomer or an amine-derivative monomer covalently bonded to the polymer substrate.

2. The method of claim 1, wherein the contacting comprises:
immersing at least part of the sorbent membrane in the source material; or
moving at least part of the sorbent membrane through the source material.

3. The method of claim 1, wherein the lithium-containing source material comprises a slurry or brine.

4. The method of claim 1, wherein the lithium-containing source material is derived from or comprises soil, coal ash, wastewater, industrial brine, natural brine, or water from a landfill.

5. The method of claim 1, further comprising, prior to the contacting, pretreating at least part of the lithium-containing source material to remove one or more cations therefrom.

6. The method of claim 1, wherein the one or more stripping processes comprises exposing at least part of the sorbent membrane to one or more acids.

7. The method of claim 6, wherein the one or more acids comprises hydrochloric acid.

8. The method of claim 1, wherein the contacting is such that a harvesting capacity of the sorbent membrane is at least 7 milligrams of lithium per gram of the plurality of monomers.

9. The method of claim 1, wherein the plurality of monomers comprises allylamine, 4-vinylpyridine, (vinylbenzyltrimethyl)ammonium, or vinylbenzyl-(methyl-di-octyl)-ammonium chloride.

10. The method of claim 1, wherein the polymer substrate comprises a polyethylene, a halogenated polymer, a polyester, a polypropylene, or a polyamide.

11. A method for fabricating a sorbent membrane for harvesting lithium ions, the sorbent membrane comprising a polymer substrate and a plurality of monomers grafted to the polymer substrate, the method comprising:
exposing the plurality of monomers and/or the polymer substrate to a dose of high-energy radiation; and
contacting the plurality of monomers with the polymer substrate, such that the plurality of monomers are covalently bonded to the polymer substrate via one or more radiation-induced graft polymerization (RIGP) reactions,
wherein the contacting is performed at a same time as or subsequent to the exposing,
the high-energy radiation comprises at least one of X-rays, a particle beam, or Gamma rays, and
the plurality of monomers comprises an amine monomer or an amine-derivative monomer.

12. The method of claim 11, wherein:
the contacting comprises immersing at least part of the polymer substrate in a solution or emulsion comprising the plurality of monomers; and
the polymer substrate is exposed to the dose of the high-energy radiation while the at least part of the polymer substrate is immersed in the solution or emulsion.

13. The method of claim 11, wherein:
the contacting comprises immersing at least part of the polymer substrate in a solution or emulsion comprising the plurality of monomers, and
the immersing is after the polymer substrate is exposed to the dose of high-energy radiation.

14. The method of claim 11, wherein the dose of high-energy radiation is in a range of 10-300 kiloGray (kGy), inclusive.

15. The method of claim 11, wherein:
(i) the plurality of monomers comprises allylamine, 4-vinylpyridine, (vinylbenzyltrimethyl)ammonium, vinylbenzyl-(methyl-di-octyl)-ammonium chloride, or any combination of the foregoing;
(ii) the polymer substrate comprises a polyethylene, a halogenated polymer, a polyester, a polypropylene, or a polyamide; or
(iii) both (i) and (ii).

16. A sorbent membrane for harvesting lithium ions, comprising:
a polymer substrate; and
a plurality of monomers grafted to the polymer substrate,
wherein the plurality of monomers comprises an amine monomer or an amine-derivative monomer covalently bonded to the polymer substrate.

17. The sorbent membrane of claim 16, wherein at least one of the plurality of monomers is allylamine or has 1-3 vinyl groups.

18. The sorbent membrane of claim 17, wherein at least one of the plurality of monomers is 4-vinylpyridine, (vinylbenzyltrimethyl)ammonium, or vinylbenzyl-(methyl-di-octyl)-ammonium chloride.

19. The sorbent membrane of claim 16, wherein the polymer substrate comprises a polyolefin, a halogenated polymer, a polyester, or a polyamide.

20. The sorbent membrane of claim 19, wherein:
the polyolefin is polypropylene, ultra-high-molecular-weight polyethylene (UHMWPE), low density polyethylene (LDPE), or high density polyethylene (HDPE);
the halogenated polymer comprises boronated or fluorinated co-polymers;
the halogenated polymer is poly(tetrafluoroethylene-co-hexafluoropropylene) (FEP) or polytetrafluoroethylene (PTFE);
the polyester is polyethylene terephthalate; or
the polyamide is nylon-6.
